(19) United States
(12) Patent Application Publication
(10) Pub. No.: US 2007/0250321 A1
(43) Pub. Date: Oct. 25, 2007

(54) PERSONAL AND REMOTE ARTICLE-ON-DEMAND SYSTEM

(75) Inventor: Prasad Sai Balusu, Rochester Hills, MI (US)

Correspondence Address: Dickinson Wright PLLC, 38525 Woodward Avenue, Suite 2000, Bloomfield Hills, MI, 48304, US

(73) Assignee: E3 Infosystems, Inc., Rochester Hills, MI (US)

(21) Appl. No.: 11/379,882

(22) Filed: Apr. 24, 2006

(51) Int. Cl. G10L 13/08

(52) U.S. Cl. 704/260

(57) ABSTRACT

A communication system (10) includes a remote personal communication device (14) that has an input device 68, 70, 72) and a data transceiver (62). The input device (68, 70, 72) receives a text article request command from a user. The data transceiver (62) transmits text article request signals in response to the text article request command and receives text article signals from an article source (12) in response to the text article request signals. A text-to-speech converter (46, 66) converts the text article signals into speech signals. An audio system (74) is coupled to the text-to-speech converter (46, 66) and audibly transmits the speech signals to the user.

### TECHNICAL FIELD

The present invention relates to communication systems, text to speech systems, and information broadcasting systems. More particularly, the present invention is related to a technique for providing written or published text in an audible format to a user or customer remotely and as desired.

### BACKGROUND OF THE INVENTION

With increasing population size comes more congested traffic situations, which are encountered by individuals day-to-day. People, in general, are spending an increasing amount of time on average traveling to and from work. This commuting between home and work occurs through the use of various types of transportation, such as automobiles, buses, monorail systems, trains, subways, cycles, or some other form of transportation.

Much of the time spent in a commute is either lost or taken up by silence, by listening to music, by listening to others nearby, and/or by some other ineffective time consuming task. For some, the commute time for a single day can be as much as 2-4 hours. The time spent traveling reduces the amount of time that one has to spend at work, at home, with ones family, etc.

In order to occupy some of the travel time and to remain informed of current events or other pertinent information, many travelers, who are not operating a vehicle, attempt to read magazines, newspapers, books, or other documents. Similarly, others attempt to read articles on a computer or via some personal electronic device, such as a cellular phone or personal data assistant (PDA). Reading while traveling can be awkward, uncomfortable, and difficult, especially in highly congested settings. Reading while traveling can also cause some to loose their balance or equilibrium, such as when standing while in a vehicle that is moving. When there is a considerable amount of walking or biking involved in ones commute, there is a reduced amount of time that can be spent reading, because of the difficulties in performing such acts simultaneously.

Thus, there is a desire for a technique or system that allows one to better utilize travel time in a more effective and productive manner that overcomes the above-stated drawbacks.

### SUMMARY OF THE INVENTION

One embodiment of the present invention provides a communication system that includes a remote personal communication device. The communication device has an input device and a data transceiver. The input device receives a text article request command from a user. The data transceiver that transmits text article request signals in response to the text article request command and receives text article signals from an article source in response to the text article request signals. A text-to-speech converter converts the text article signals into speech signals. An audio system is coupled to the text-to-speech converter and audibly transmits the speech signals to the user.

Another embodiment of the present invention provides a central broadcast station and a remote personal communication device. The broadcast station transmits text article signals for a plurality of articles. The remote personal communication device includes a data transceiver and an input device. The data transceiver receives the text article signals and the input device receives a text article request command from a user. A controller selects a text article signal in response to the text article request command and a user associated service access code. A text-to-speech converter converts the selected text article signals into speech signals. The audio system is coupled to the text-to-speech converter and audibly transmits the speech signals to the user.

The embodiments of the present invention provide several advantages. One such advantage is a personal communication device that converts and audibly transmits the material within selected articles to a user. The personal communication device may be portable or integrally coupled within a vehicle or the like. This allows the user to listen to the material contents of an article remotely. As such, the user is able to maintain eye contact on an environment while at the same time obtaining desired information. The stated device provides effective and productive use of travel time.

Another advantage that is provided by an embodiment of the present invention is a personal communication device that converts and audibly transmits selected articles to a user, which prevents access to selected articles based on predetermined criteria.

Yet another advantage provided by an embodiment of the present invention is a text article transmitting system for personal communication device access that monitors services provided, facilitates payment for the services, and prevents further access to the services and the like when a user balance is unpaid.

Furthermore, the present invention provides a text article-on-demand system that wirelessly transmits selected articles to remotes users for reception any where within a servicing area. This allows for reception of desired articles when traveling on various types of transportation without the need for carrying the text or audio cassettes, CDs, or the like onto a vehicle.

The present invention provides a text article-on-demand system that is cost effective, is capable of being easily implemented, and increases safety associated with vehicle operation and traveling in general.

The present invention itself, together with further objects and attendant advantages, will be best understood by reference to the following detailed description, taken in conjunction with the accompanying drawing.

### BRIEF DESCRIPTION OF THE DRAWINGS

For a more complete understanding of this invention reference should now be had to the embodiments illustrated in greater detail in the accompanying figures and described below by way of examples of the invention wherein:

FIG. 1 is a block diagrammatic view of a text article-on-demand system in accordance with an embodiment of the present invention;

FIG. 2 is a block diagrammatic view illustrating communication between a PCD and an article source of the text article-on-demand system in accordance with an embodiment of the present invention;

FIG. 3 is a schematic of a text article-on-demand architecture in accordance with an embodiment of the present invention;

FIG. 4 is a data flow diagram illustrating service monitoring, accounting, and associated fee calculation for text article services in accordance with an embodiment of the present invention;

FIG. 5A is an illustration of a sample screen in accordance with an embodiment of the present invention;

FIG. 5B is an illustration of another sample screen in accordance with an embodiment of the present invention; and

FIG. 6 is a logic flow diagram illustrating a method of audibly providing written materials to a remote system user in accordance with an embodiment of the present invention.

### DETAILED DESCRIPTION

In the following figures the same reference numerals will be used to refer to the same components. While the present invention is described with respect to a system and method of providing, converting, and audibly transmitting text articles to remote users, the present invention may be applied in various applications. The present invention may be utilized in association with various vehicles and personal communication devices. Also, a variety of other embodiments are contemplated having different combinations of the below described features of the present invention, having features other than those described herein, or even lacking one or more of those features. As such, it is understood that the invention can be carried out in various other suitable modes.

In the following description, various operating parameters and components are described for one constructed embodiment. These specific parameters and components are included as examples and are not meant to be limiting.

Also, in the following description the term “text article” or “article” may refer to magazine articles, newspaper articles, book writings, pamphlets, published works, journals, reports, course or class materials, documents, subscription writings, dated materials, collections, or other written materials. The text articles or articles may be provided as a service to various customers or subscription holders.

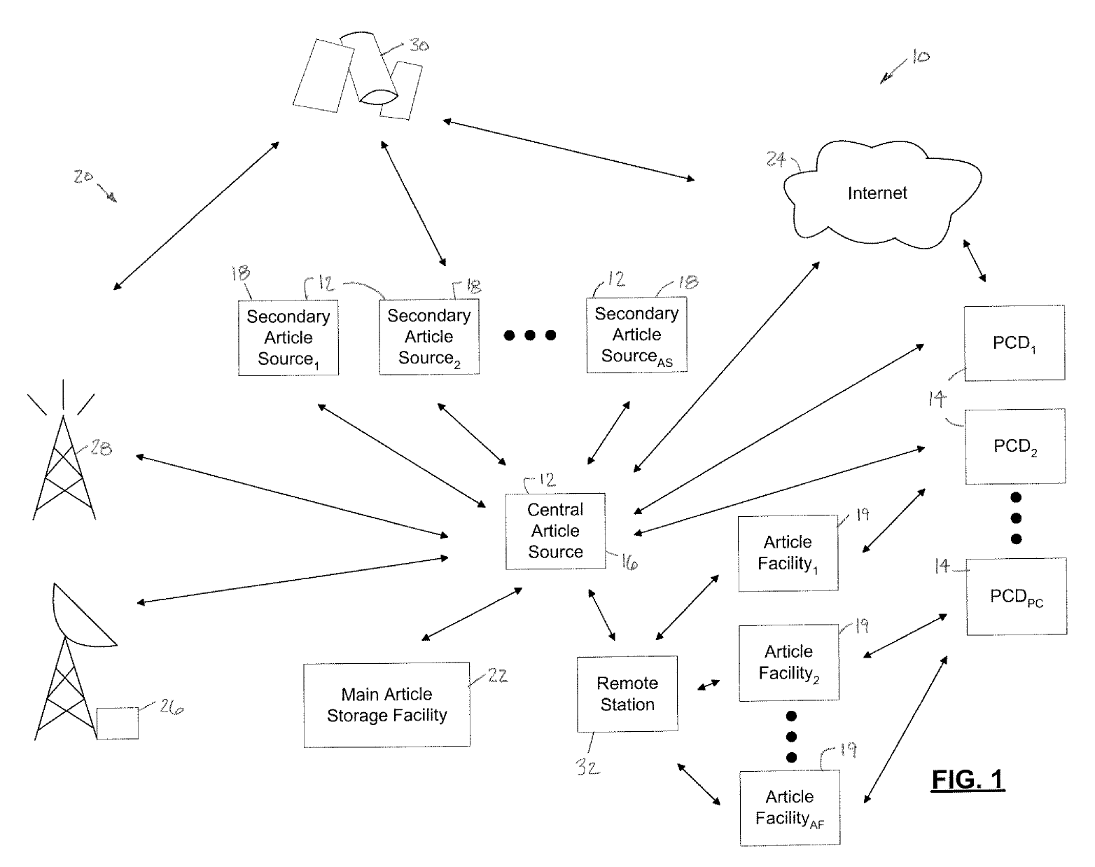

Referring now to FIG. 1, a block diagrammatic view of a text article-on-demand communication system 10 in accordance with an embodiment of the present invention is shown. The on-demand system 10 includes one or more article sources 12 (only one is shown) and various personal communication devices 14 (PCDs) associated with user/customers that are in communication therewith. The article sources 12 provide an article-on-demand service to the customers. The customers remotely and as desired select articles of their choosing, which are transmitted in a text format or a speech format to the customers. The articles are converted into a speech format either prior to or upon reception by the PCDs 14. The articles may then be audibly played for the listening pleasure of the customers.

The article sources 12 may be in the form of central offices, remote stations, magazine/newspaper stands, book stores, publishing houses, written material outlets, on-line written material stores or clubs, subscription companies, or the like. In the example embodiment, a primary or central article source 16 is shown and is in communication with secondary article sources 18. The central article source 16 may provide the article-on-demand services and acquire the articles from the secondary article sources 18. The articles may also be provided directly to the PCDs 14 via the article sources 12 or via the article facilities 19. The central article source 16 may have one or more websites associated therewith for access to the services provided therefrom.

The article sources 12 are part of a telecommunication network 20 and may receive, request, acquire, and/or store various articles, article collections, or article references. For examples the article sources 12 may store an article, a set or group of articles containing the stated article, a reference having the stated article, a series of references having the stated article, or some other reference from which the article is contained. The article sources 12 may be associated with a published work, a series, a news reference, a public or private information reference, a subscription or periodical reference, and a reporting column. The article sources 12 may be associated with an instruction institution, a facility, or a business.

The article sources 12 are in communication with and may provide and receive articles to and from a main article storage facility 22 and the Internet 24. The article sources 12 may communicate wirelessly, directly, or indirectly to the PCDs 14, such as via gateway(s) 26, land-based station(s) 28, satellite(s) 30, remote station(s) 32, or via some other forms or avenues of communication known in the art. Such communication may occur via the Internet 24.

The telecommunication network 20 may be or be part of an Intranet, an integrated services digital network, a digital subscriber network, a wireless network, a local area network, a wide area network, a personal area network, a campus area network, a metropolitan network, or other internal or external network known in the art. The telecommunication network 20 may include load balancing and filter devices, ad servers, modems, and other internal network componentry and communication devices known in the art. For example, modems, hubs, and other interactive communication facilities, ports, and junctions may be incorporated in the network 20. The telecommunication network 20 may be analog or digital based and operate via various known wired and wireless protocols known in the art such as bluetooth and wireless fidelity, and may follow various Institute of Electronic and Electrical Engineers (IEEE™) standards.

The PCDs 14 are also part of the telecommunication network 20 and may be of various types and styles. The PCDs 14 may be in the form of a cellular phone, a personal data assistant, a computer, a vehicle communication system, or in some other form known in the art. The PCDs 14 may be portable or integrally mounted on a mobile unit, such as a vehicle, a cart, a trailer, or on some other mobile unit.

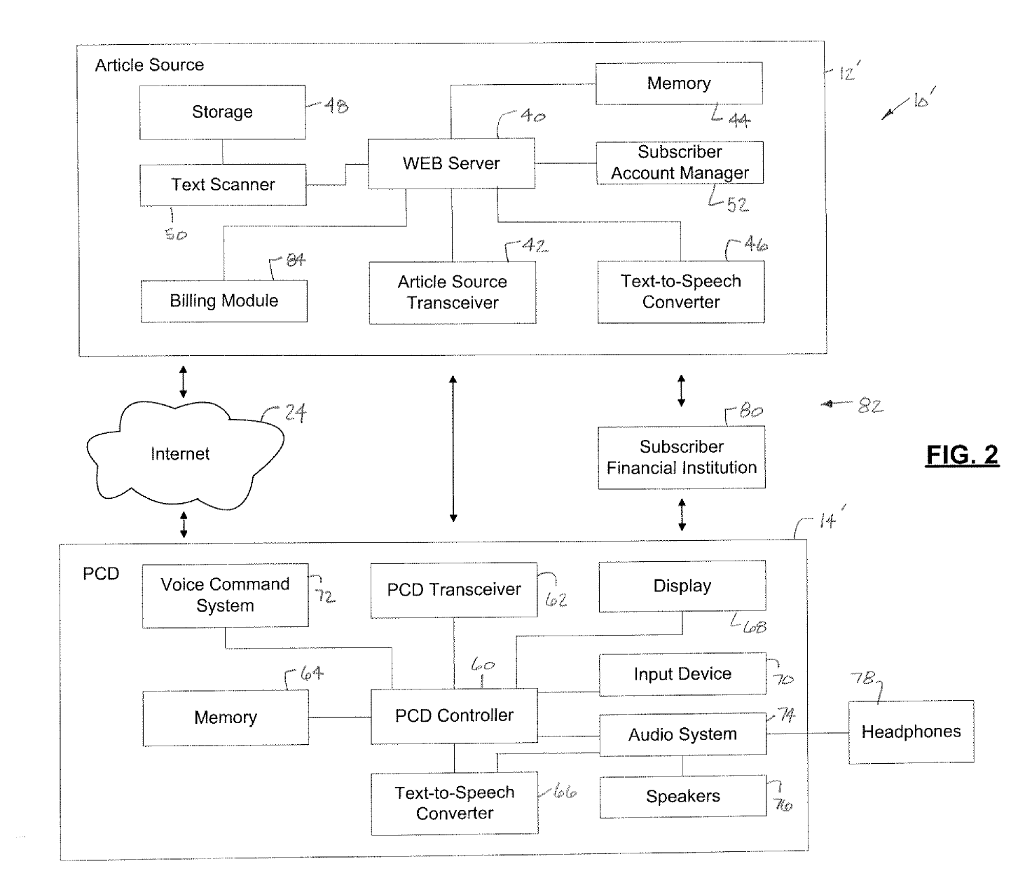

Referring now to FIG. 2, a block diagrammatic view illustrating communication between an article source 12′ and a PCD 14′ of a text article-on-demand system 10′ in accordance with an embodiment of the present invention is shown. The article source 12′ and the PCD 14′ contain several devices or modules, which may all be software or hardware based.

The article source 12′ includes a controller/web server 40, which communicates to the PCD 14′ by use of the article source transceiver 42. The article source 12′ may be referred to as a subscription provider and may include one or more memory units 44 (only one is shown), a text-to-speech converter 46, a physical storage unit 48, and a text scanner 50. The memory 44 may be used to store a variety of articles in either text format or speech format The text-to-speech converter 46 may be used to convert articles prior to transmission to the PCD 14′. The physical storage unit 48 may be in the form of a library and used to store hard copies or versions of articles and article references. The physical storage unit 48 may be coupled to the text scanner and in combination thereof may be used to systematically scan a selected article. The text scanner 50 may be in the form of a manual scanner in which human intervention is needed or may be automated by which the scanner physically selects a particular article or article reference from the storage unit for scanning.

A subscriber account manager 52 is coupled to the web server. The account manager 52 may be part of or external to the article source 12′ or part of the web server 40. The account manager 52 monitors and administers various tasks such as those associated with the archiving and or removal of old inactive accounts, the care of existing accounts, and the creation and procurement of new accounts. The account manager 52 also assigns user service codes to each user account for identification, ranking, and other account associated characteristics. The account manager 52 may, through the use of the service codes, prevent service to a particular account due to a user unpaid balance, a parental associated signal blocking parameter, an instructor associated parameter, a security parameter or for other desired reasons.

The PCD 14′ may be considered a communication system in and of itself. The PCD 14′ includes a PCD controller 60 that is in communication with the article source 12′ via a PCD transceiver 62. The PCD 62 may also include a memory 64 and a text-to-speech converter 66. The memory 64 may be used for the storing of received articles in a text or speech format. Articles are selected on the PCD 14′ via the use of one or more of a display 68, an input device 70, a voice recognition, operating, or command system 72, or via some other input device or technique known in the art. The display 68 may be a touch screen display to allow for direct selection thereon. The display 68 and the command system 72 can be referred to as input devices. The input device 70 may be in the form of a keyboard, a mouse, a touch pad, a keypad, or some other input or data entry device.

The PCD 14′ also includes or is coupled to an audio system 74. The audio system 74 may have speakers 76 and/or headphones 78 coupled thereto. The audio system 74 is used to audibly transmit a selected article in a speech or speaking format for user listening pleasure.

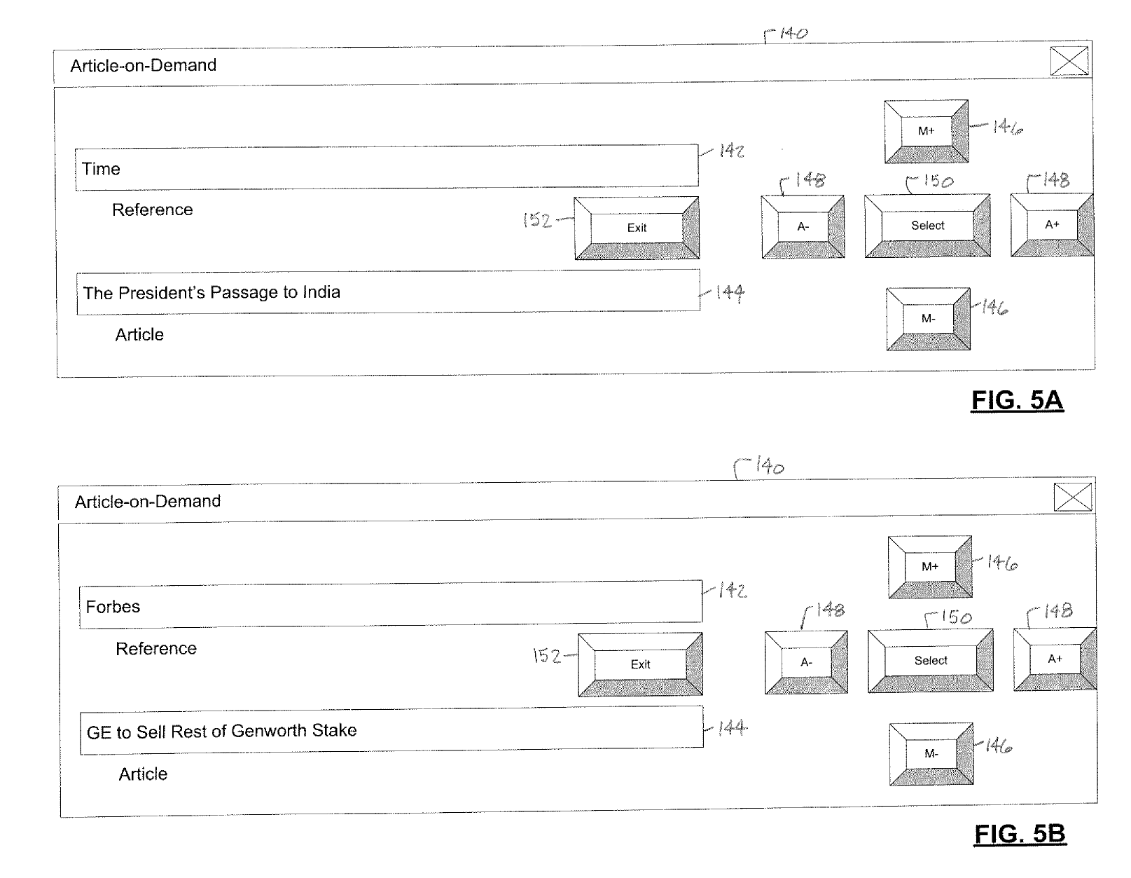

The PCD 14′ has a variety of screens, buttons, and indicators (some of which are shown in FIGS. 5A and 5B. The PCD 14′ may have an article-on-demand activation button (not shown) for accessing an article-on demand website or source. The PCD 14′ may also have an execute button (not shown) associated with activating the playing of a desired or selected article. Some other button examples are described with respect to FIG. 5.

The web server 40 and the PCD controller 60 may be microprocessor based such as computers having central processing units, memories (RAM and/or ROM), and associated input and output buses. The web server 40 and the PCD controller 60 may be application-specific integrated circuits or may be formed of other logic devices known in the art. The web server 40 and the PCD controller 60 may be a portion of a central vehicle main control unit, a control circuit having a power supply, combined into a single integrated controller, or may be a stand-alone controller as shown.

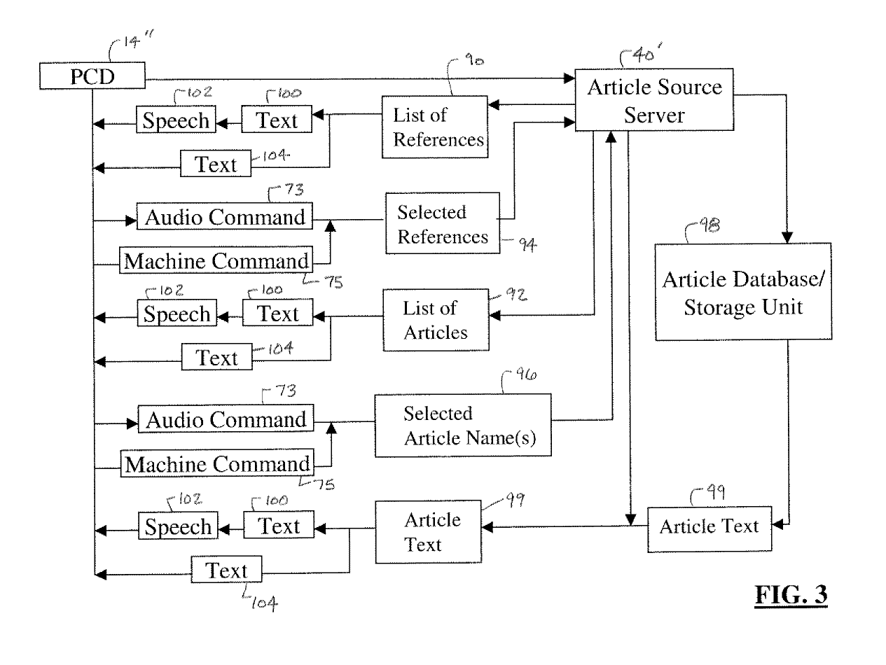

Various forms of information may be provided by the article source 12′. A couple examples of which are described with respect to FIGS. 3-6. The article source 12′ may, for example provide article materials, reference or article information, subscription information, accounting information, as well as advertisements, system updates, or other related information.

In another embodiment of the present invention, the article source 12′ and/or the PCD 14′ are in communication with a subscriber financial institution 80. As such, the article source 12′ and the PCD 14′ may be part of an electronic fund disbursement system 82, which allows for the transferring of funds from an account of a user to the article source 12′. The electronic fund disbursement system 82 includes a billing module 84 of the article source 12′, which is in communication with the financial institution 80. The financial institution 80 may be in the form of a bank, a credit card company, a credit union, a money market account organization, or some other monetary source in which the user of the PCD 14′ has an account. The billing module 84 may obtain billing information, such as credit card numbers, account numbers, fund transfer authorization numbers, user identification information, or other known billing information from the user, thereby authorizing the article source 12′ to draw funds from an account of the users choosing.

The billing module 84 may draw funds when setting up an account, when a particular sale is made, periodically, regularly, or by some other format. For example, a subscription or membership fee may be paid when an account is setup and monthly dues or fees may be drawn automatically from the users account while the services to the user are active.

The billing module 84 may also be used as a user balance notification device to generate monthly billing reports, to notify a user when a balance is past due, and to generate warning signals indicative of service cancellation or possible service cancellation. The billing module 84 may signal the web server 40 or account manager to prevent transmission of articles or text article signals to a user when the associated user account is past due.

Referring now also to FIG. 1, the payments received by the users or a portion thereof may be distributed from the central article source 16 to the secondary article sources 18. The distribution may be based on the frequency of article retrieval from each secondary article source 18. A portion of the payments received may be retained by the central article source 16 for providing article-on-demand services, operational expenses, and other related costs and expenses.

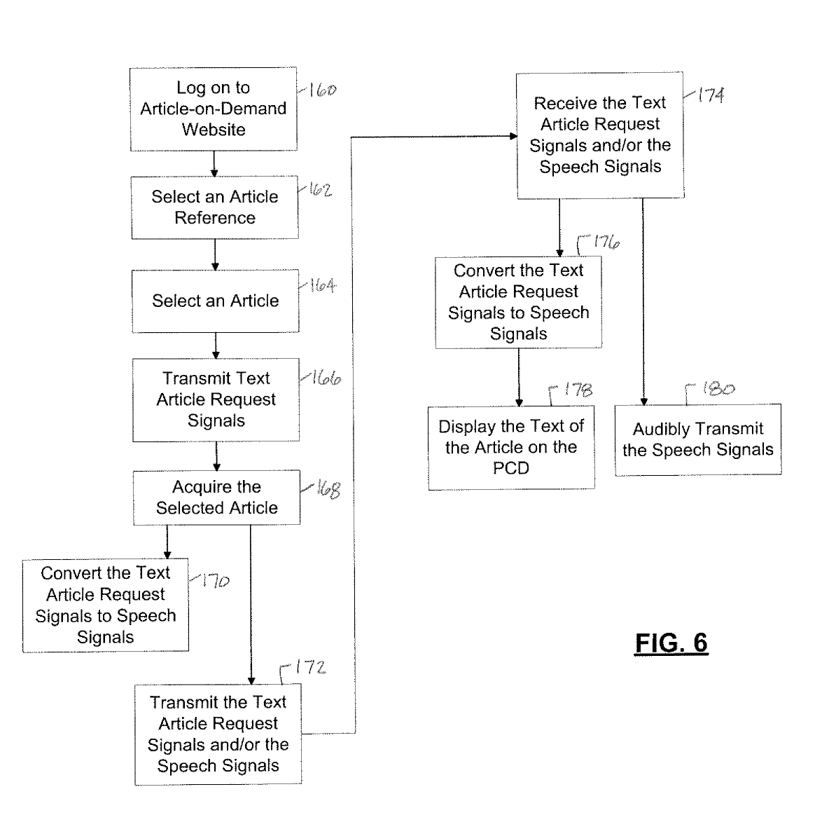

Referring now also to FIG. 3, a schematic of a text article-on-demand architecture in accordance with an embodiment of the present invention is shown. A PCD 14″, such as one of the PCDs 14 and 14′, is initially connected to an article source server 40′. The server 40′ provides a list of references 90 and a list of articles 92 that may be selected. The lists 90 and 92 may be provided on the display 68 and/or may be converted into a speech format and audibly stated to the user via one of the text-to-speech converters 46 or 66 and the audio system 74. The user selects the desired references and articles either verbally, by way of the voice command system 72, or through physically inputted commands using one or more of the input devices 68 and 70. Verbal commands are represented by audio command boxes 73 and inputted commands are represented by machine command boxes 75. The reference and article selections are further described below with respect to the embodiments of FIGS. 5 and 6.

The article source server 40′ in response to the selected references 94 and article names(s) 96 retrieves the same from an article database or storage unit 98, such as the storage unit 48, the storage facility 22, or the memory 44. The article(s) 99 may be converted into a speech format by the article source server 40′, may be received by the article source server 40′ in a text format or a speech format, and then provided to the PCD 14″ in a text format, in a speech format, or in a combination thereof.

In FIG. 3, text-to-speech conversion that is performed prior to reception by the PCD 14″ for the list of references 90, the list of articles 92, and the articles 99, is represented by boxes 100 and 102 for the text formats and the speech formats, respectively. The providing of the list of references 90, the list of articles 92, and the articles 99 in a text format is represented by boxes 104.

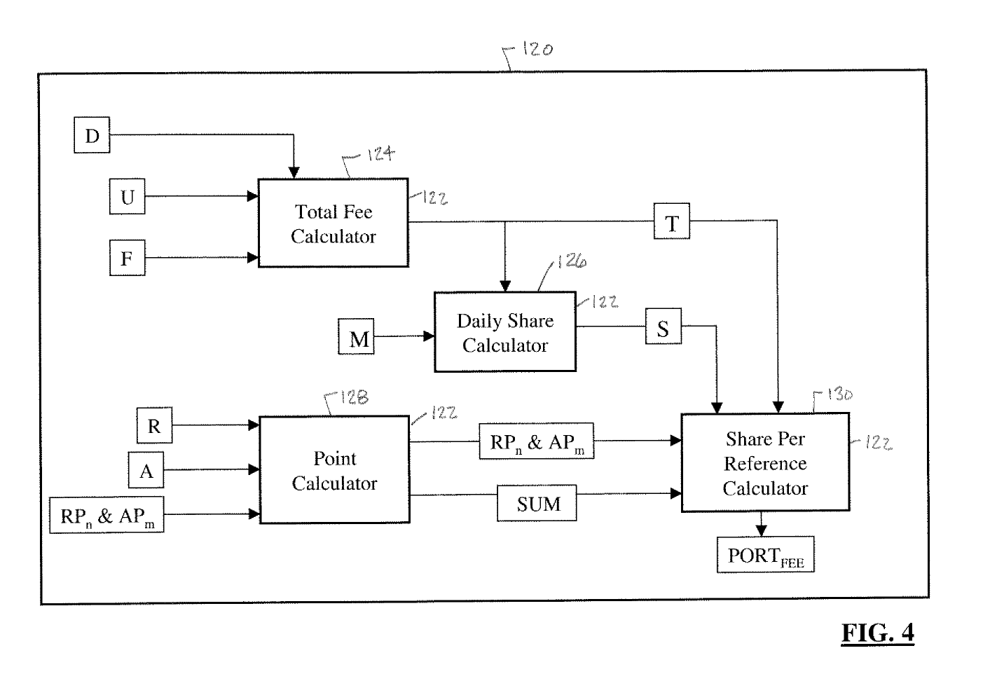

Referring now to FIG. 4, a data flow diagram illustrating service monitoring, accounting, and associated fee calculation for text article services in accordance with an embodiment of the present invention is shown. The providing of articles to users may be monitored in entirety or on an individual basis by an article source or central office via a calculation device 120. The calculation device 120 may be in communication with and provide bills, reports, status updates, or other pertinent information to one or more of the above-described PCDs 14, 14′, and 14″. The calculation device 120 may be in the form of a controller or a server, such as the server 40, or a module thereof. Parameters, such as days in a particular month, total number of users, monthly user fees, share percentages between users, references accessed, articles accessed, reference points, and various other parameters (not shown) may be monitored, stored, accounted, and evaluated. Some other parameters may include dates of use, times of use, user fees, accounts per household, and accounts per business client.

The calculation device 120 includes several modules 122. The modules 122 may be software or hardware based, be part of a single unit as shown, or may be separate stand-alone devices. Although a particular number and type of modules are shown, and number of which may be used and they may be modified and include other fee or accounting related modules known in the art. In the embodiment shown, the calculation device 120 includes a total fee calculator 124, a daily share calculator 126, a point calculator 128, and a share per reference calculator 130.

The total fee calculator 124 determines the total service fee collected per day T based on the days in a particular month D, the number of users for that month U , and the monthly user service fee F, as represented by equation 1.

$$T = \frac{UF}{D} \qquad ( 1 )$$

The user daily share M is multiplied by the total fee T to obtain a user daily share of the total fee S, as represented by equation 2, via the daily share calculator 126.
S=MT (2)

The point calculator 128 determines a daily number of points SUM associated with the articles for each of the users separately or in combination. The references accessed R, the articles accessed A, and the points associated for each RPₙ and APₘ, where n and m are integer numbers, are summed to generate the daily points SUM. Look-up-tables may be used to determine the points RPₙ and APₘ. In one embodiment, each instance when an article is downloaded or otherwise provided to the user the articles accessed A is incremented by one. In other words, each article accessed has an associated one-point value. The point SUM is incremented each time the articles accessed A is incremented. Each reference and article may have any number of points associated therewith.

The total fee T, the daily share S, the reference points RPₙ, the article points APₘ, and the daily points SUM are used by the share per reference calculator 130 to determine a user daily share of the fees associated with a particular reference PORT_{FEE}, as represented by equation 3.

$${PORT}_{FEE} = \frac{T - S}{SUM} ( {RP}_{n} + {AP}_{m} ) \qquad ( 3 )$$

Note that the calculations, the equations, and the modules, described above are provided for example purposes only. Other calculations, equations, expressions, formulas, and modules may be utilized depending upon the application.

Referring now to FIG. 5A-B, illustrations of sample selection screens 140 in accordance with an embodiment of the present invention are shown. The screens 140 shown have reference identifying inputs 142, article identifying inputs 144, article reference selectors 146, and article selectors 148. The user selects a reference for an article and the article by scrolling through a provided list of references and a list of articles associated with each reference.

The reference selectors 146 and the article selectors 148 may have associated directional incrementing buttons, respectively, as shown. In the embodiments shown, the selectors 148 share a select button 150. The user upon entering or finding the desired reference and article may press the select button 150 to begin transmission and reception of the article. Screen exit buttons 152 are also shown.

Although a single reference identifying input 142 and a single article identifying input 144 are shown, any number of each may be incorporated and each of which may be of various types and styles. Some further examples of reference identifying inputs are a reference title input, a topic input, a publisher input, an address of an article source input, a phone number of an article source input, and a geographical location of an article source input. Some further examples of article identifying inputs are a title input, an author input, a date input, a publisher input, and a subject input.

Referring now to FIG. 6, a logic flow diagram illustrating a method of audibly providing written materials to a remote system user in accordance with an embodiment of the present invention is shown.

In step 160, a user, via a PCD or other communication device, logs onto an article-on-demand website or enables communication with an article-on-demand server or the like.

In step 162, the user selects an article reference, such as described with respect to FIG. 5. A list of references may be provided on a display and/or audibly stated such that they may be heard by the user. The user in selecting the reference may physically through contact with the PCD select the reference or may verbally state a selection. The reference may be selected by entering, selecting, or verbally stating any number of reference identifiers or by simply answering and stating Yes or No.

In step 164, the user selects a text article, such as described with respect to FIG. 5. Like with the reference selection, a list of offered article names may be provided on a display and/or audibly stated to be heard by the user. The user in selecting the article may physically through contact with the PCD select or verbally state a selection. The article may be selected by entering, selecting, or verbally stating any number of article identifiers or by simply answering and stating Yes or No in response to offered reference names.

In step 166, the user associated PCD remotely generates and transmits text article request signals to an article source, such as one of the article sources, in response to the selected article reference and article. In step 168, the article source acquires the selected article in response to said text article request signals. In step 170, the article source may convert the text article request signals from a text format to a speech format to generate speech signals. In step 172, the article source transmits the text article signals and/or the speech signals to the PCD.

In step 174, the PCD remotely receives the text article signals and/or the speech signals. In step 176, the PCD may convert the text article signals into speech signals. In step 178, the PCD displays the text of the selected article on the display. The text may be automatically displayed or displayed as a result of a user command. In step 180, an audio system, such as the audio system 74, audibly transmits the speech signals to the user.

Upon completion of the article, the user may elect to review or replay the article or return to step 162 for another selection. The downloaded article may be stored on the PCD, stored on the PCD for a temporary period of time, or security provisions may be placed to prevent the user from storing and/or reproducing the text article signals and the speech signals.

The above-described steps are meant to be illustrative examples; the steps may be performed sequentially, synchronously, simultaneously, or in a different order depending upon the application.

The present invention provides an article-on-demand system that remotely provides users with user selected articles when desired in a speech or audible format. The system provides one with the capability of listening to desired text during a commute or otherwise from a remote location for efficient use of travel time.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A communication system comprising:
a remote personal communication device comprising;
an input device receiving a text article request command from a user; and
a data transceiver coupled to said input device, transmitting text article request signals in response to said text article request command, and receiving text article signals from an article source in response to said text article request signals;
a text-to-speech converter converting said text article signals into speech signals; and
an audio system coupled to said text-to-speech converter and audibly transmitting said speech signals to said user.

2. A system as in claim 1 wherein said text article is received through a subscription service provider.

3. A system as in claim 1 wherein said remote personal communication device is selected from at least one of a cellular phone, a personal data assistant, a computer, and a vehicle communication system.

4. A system as in claim 1 wherein said remote personal communication device comprises:
at least one reference identifying input;
at least one article identifying input; and
a controller generating said text article request signals in response to said at least one reference identifying input and said at least one an article identifying input.

5. A system as in claim 4 reference identifying input comprises a reference title input, a topic input, a publisher input, an address of an article source input, a phone number of an article source input, and a geographical location of an article source input.

6. A system as in claim 4 wherein said article identifying input comprises at least one input selected from a title input, an author input, a date input, a publisher input, and a subject input.

7. A system as in claim 1 wherein said remote personal communication device comprises an article reference selector allowing said user to scan for and select a reference of a desired article.

8. A system as in claim 1 wherein said remote personal communication device comprises an article selector allowing said user to scan for and select a desired article.

9. A system as in claim 1 wherein said input device is selected from at least one of a display, a touch screen, a keypad, a keyboard, a mouse, a voice recognition system, a voice operated system, and a touch pad.

10. A system as in claim 1 further comprising a fee calculator in communication with said remote personal communication device and determining a service fee associated with reception of said text article signals.

11. A system as in claim 10 further comprising an electronic fund disbursement system transferring funds from an account of said user to pay said service fee.

12. A system as in claim 10 wherein said electronic fund disbursement system transfers said funds upon transmission of said text article signals.

13. A system as in claim 1 further comprising a user balance notification device in communication with said remote personal communication device and generating a warning signal indicative of service cancellation.

14. A system as in claim 1 further comprising at least one headset coupled to said remote personal communication device and audibly transmitting said speech signals.

15. An information broadcasting system comprising:
a central broadcast station transmitting text article signals for a plurality of articles;
a remote personal communication device comprising;
a data transceiver receiving said text article signals;
an input device receiving a text article request command from a user; and
a controller selecting at least one of said text article signals in response to said text article request command and a user associated service access code;
a text-to-speech converter converting said selected text article signals into speech signals; and
an audio system coupled to said text-to-speech converter and audibly transmitting said speech signals to said user.

16. A system as in claim 15 wherein said central station prevents transmission of said text article signals in response to at least one of a user service code, a user unpaid balance, a parental associated parameter, an instructor associated parameter, and a security parameter.

17. A system as in claim 15 wherein said remote personal communication device comprises said text-to-speech converter.

18. A system as in claim 15 wherein said remote personal communication device comprises said audio system.

19. A method of audibly providing written materials to a remote system user comprising:
selecting an article reference;
selecting an article;
remotely generating and transmitting text article request signals in response to said article reference and said article;
acquiring said text article from an article source in response to said text article request signals and transmitting text article signals;
remotely receiving said text article signals;
converting said text article signals into speech signals; and
audibly transmitting said speech signals to said user.

20. A method as in claim 19 wherein transmitting said text article signals comprises wirelessly transmitting said text article signals to a personal communication device.
